(19) United States
(12) Patent Application Publication
(10) Pub. No.: US 2007/0188985 A1
(43) Pub. Date: Aug. 16, 2007

(54) Disconnect collar for power line carrier metering transponder

(76) Inventors: Bennett D. Wallace JR., Elk River, MN (US); Robert J. Cox, Carrington, ND (US); Kevin Allmaras, Carrington, ND (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 11/344,953

(22) Filed: Jan. 31, 2006

(51) Int. Cl. H02B 1/00

(52) U.S. Cl. 361/664; 700/295

(57) ABSTRACT

A remote disconnect collar is provided for use with an electric meter that includes a transceiver for receiving and replying to messages from a master device, such as a CCU, in a PLC type AMR system and also for transmitting connect/disconnect messages to the collar. The collar is provided with a receiver for receiving a connect/disconnect message from the meter, and no hard-wired connection exists between the collar and the meter. Preferably, the remote disconnect collar utilizes a pair of selectively mateable male-female blades that correspond to the connectors in the meter and the interface in a friction fit between the electric meter and the meter socket.

### FIELD OF THE INVENTION

The present invention relates generally to power line carrier metering systems. More specifically, the invention relates to methods and apparatus for an improved meter and disconnect collar arrangement.

### BACKGROUND OF THE INVENTION

Electric meter reading systems in which a reader device communicates with remote endpoint meter devices are used by utilities and other companies to improve the efficiency of the meter reading process and reduce the opportunity for erroneous readings. Such an arrangement is called automatic meter reading (AMR). This communication may be accomplished in a variety of ways, with one such way being power line communication (PLC).

Devices associated with PLC systems are often referred to as power line carrier devices. An AMR system incorporating PLC utilizes existing power lines to transmit messages between a power substation and a meter (or other power line carrier device). A power substation, or central control unit (CCU), includes a transmitter for communicating messages to the meter. A meter in a PLC system includes a transceiver for receiving messages, and transmitting information to the CCU. A traditional PLC system can be thought of as a master/slave arrangement, wherein the CCU is the master, and the meter is the slave.

The PLC system can be used in an AMR system to read power consumption data, and it may also be used for other functions, such as remotely connecting or disconnecting a meter. Traditionally, a utility company employee must physically go to the location of the meter to connect or disconnect the meter. This is often costly, and in the case of rural locations, can be very time-consuming. These problems are compounded in situations where the meters require frequent connecting and disconnecting, such as in student housing complexes with high turnover, or with customers having chronic payment problems.

In order to implement a remote connect/disconnect feature for a meter, a disconnect collar is commonly used. Also sometimes referred to as a sleeve, the disconnect collar is installed between the socket and the meter. A high amperage (usually 200 A) magnetic relay is used to provide the disconnect ability. Alternatively, 15 the meter itself may contain the connect/disconnect feature, but it can be difficult to package the required components within the meter housing, and is usually cost prohibitive. Meters are expensive items, and replacing an existing meter for one having remote disconnect capabilities is an unfavorable solution. Further, it would be impractical to retrofit existing meters with the components required for remote disconnect capability.

A meter in a typical PLC system having AMR capabilities includes a transceiver for receiving messages from the CCU, and for sending responses back to the CCU. For AMR functions, the meter can report not only power usage, but also tampering and outage. In current PLC remote disconnect arrangements, the disconnect collar is either hard-wired to the meter and receives disconnect messages from the CCU through the meter, or the disconnect collar includes its own transceiver for receiving disconnect messages directly from the CCU. In either case, the system is still a traditional master/slave arrangement, wherein the CCU is the master and the meter and collar are slaves.

The use of a transceiver in the disconnect collar adds expense to the system, and has the disadvantage that the meter cannot communicate with the disconnect collar, therefore the meter will not know if power has been disconnected or connected. Remote verification of a successful disconnect is not possible, and a utility employee must be dispatched to verify the status of the meter.

By hard-wiring the disconnect collar to the meter, the collar is not easily removable or transferable to another location, and the meter must be of a special type, i.e., a meter able to be adapted to the specific disconnect collar. It would be desirable to be able to move remote disconnect collars to different locations. In order to do so, the meter and disconnect collar must either have their hard-wiring undone, or be moved together. However, the meter usually contains an identification number that is associated with a particular location, and once the meter/collar combination is removed, a new meter with a new identification number must be put in its place, adding complexity to the task. Moving the meter is therefore not a viable option. Additionally, by hard-wiring the collar and the meter, the meter must also be provided with supporting driver hardware to communicate with the collar.

There exists a need, therefore, for an inexpensive remote disconnect collar that can be easily installed and uninstalled from electric meters.

### SUMMARY OF THE INVENTION

The present invention meets the aforementioned needs of the industry. Through various embodiments, the present invention comprises a remote disconnect collar for use with an electric meter. The meter includes a transceiver for receiving and replying to messages from a master device, such as a CCU, in a PLC type AMR system and also for transmitting connect/disconnect messages to the collar. The collar is provided with a receiver for receiving a connect/disconnect message from the meter, and no hard-wired connection exists between the collar and the meter. Preferably, the remote disconnect collar utilizes a pair of selectively mateable male-female blades that correspond to the connectors in the meter and the interface in a friction fit between the electric meter and the meter socket.

The present invention also comprises a method of disconnecting and connecting power to a metered location in a PLC type AMR system. The method comprises transmitting a message to the transceiver of a meter from a control station, receiving the message by the meter, and transmitting the message from the meter to a receiver in the collar. Once the message has been received by the collar, the collar activates a relay to either connect or disconnect power, in correlation with the message request.

One embodiment of the present invention has the ability to support a load-limiting function, wherein power can be temporarily disconnected if a predetermined energy usage limit is exceeded, and then reconnected shortly thereafter.

One advantage of the present invention that the collar may be quickly and easily disconnected from the meter and socket, and moved to another location.

A further advantage of the present invention is that the collar may be used with a conventional power line carrier meter, the meter needing only software installed to communicate with the collar. As a result, in this embodiment of the present invention only one style of meter need be used by the utility company.

A still further advantage of the present invention is that the collar need only be equipped with a receiver for receiving connect or disconnect messages, and the meter uses an already installed transceiver to transmit connect or disconnect messages to the collar.

### BRIEF DESCRIPTION OF THE DRAWINGS

The present invention can be more completely understood and appreciated by referring to the following more detailed description of the presently preferred exemplary embodiments of the invention in conjunction with the accompanying drawings, of which:

FIG. 1 is a front elevational view of a disconnect collar according to the present invention.

FIG. 2 is a front elevational view of an electric meter installed on a disconnect collar.

FIG. 3 is a partially exploded front elevational view of an electric meter and a disconnect collar.

FIG. 4 exploded perspective view of a meter socket, a disconnect collar and an electric meter.

FIG. 5 is an exploded perspective view of a disconnect collar.

FIG. 6 is a top view of a disconnect collar having certain components removed for clarity.

FIG. 7 is a top view of a disconnect collar having certain components removed for clarity.

FIG. 8 is a block diagram of the major electrical components of a disconnect collar.

FIG. 9 is a circuit diagram of a portion of FIG. 8.

FIG. 10 is a circuit diagram of a portion of FIG. 8.

FIG. 11 is a circuit diagram of a portion of FIG. 8.

FIG. 12 is a diagram depicting a disconnect collar as part of a power line communication system.

### DETAILED DESCRIPTION OF THE DRAWINGS

In the following detailed description of the present invention, numerous specific details are set forth in order to provide a thorough understanding of the present invention. However, it will be obvious to one skilled in the art that the present invention may be practiced without these specific details. In other instances, well-known methods, procedures, and components have not been described in detail so as to not unnecessarily obscure aspects of the present invention. It is contemplated that the present invention is compatible with all existing electrical standards.

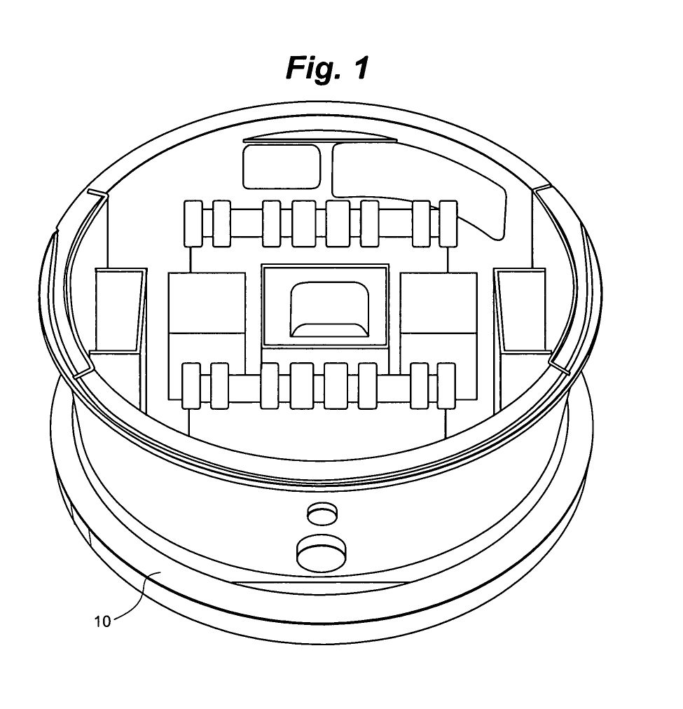

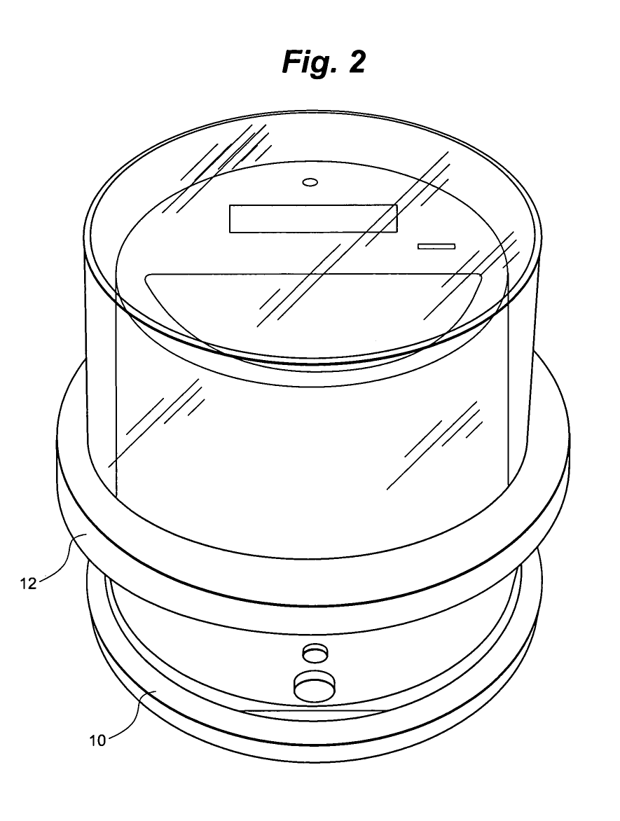

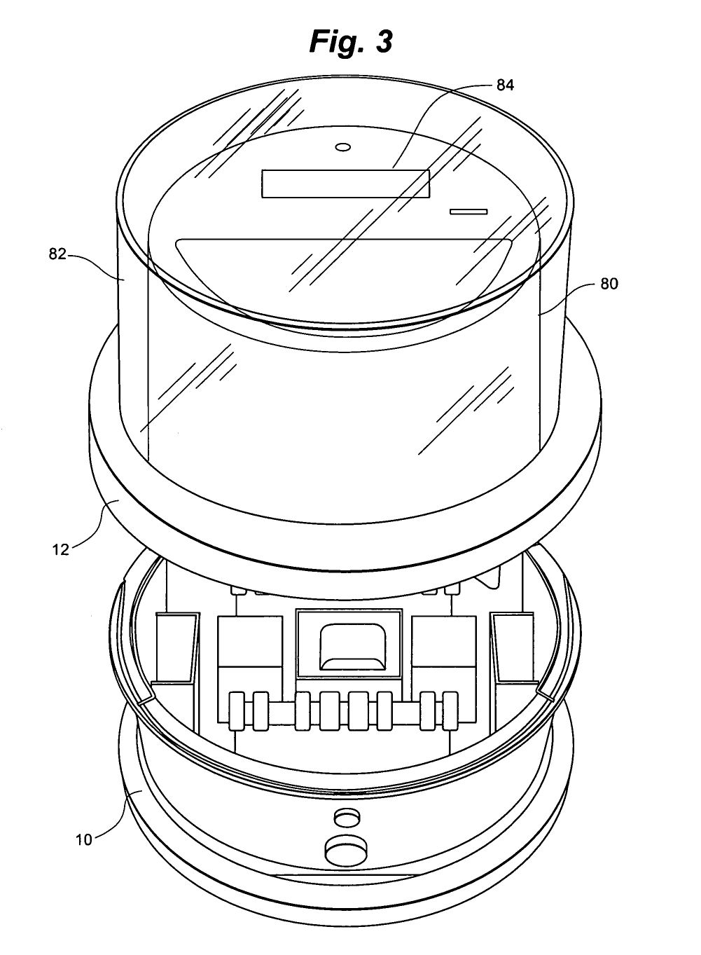

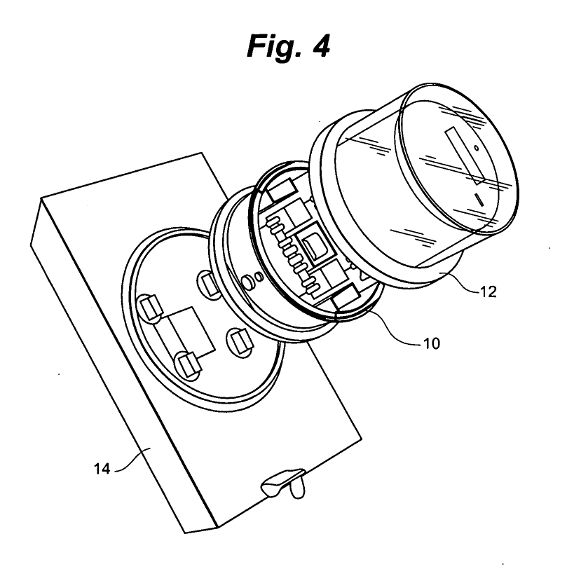

Referring generally to FIGS. 1-4, a remote connect/disconnect collar 10 is shown. Disconnect collar 10 is operably coupled between an electric meter 12 and a meter socket 14. Electric meter 12 is preferably a standard digital solid-state meter having software and hardware for communicating with collar 10, such as a MCT-410, manufactured by Cannon Technologies, Inc., assignee of the present invention. However, it is contemplated that a mechanical meter could be adapted to be operable with collar 10. Collar 10 and meter 12 are adapted for power line communication (PLC), wherein data is transmitted over existing electricity networks. Electric meter 12 includes a housing 80, a transparent outer cover 82, and a display 84. Electric meter 12 also includes a transceiver 86 (not shown) for receiving and sending messages. An ideal transceiver is disclosed in U.S. Pat. No. 4,746,897 to Shuey, the disclosure of which is hereby incorporated by reference. Transceiver 86 is configured to receive and transmit PLC signals.

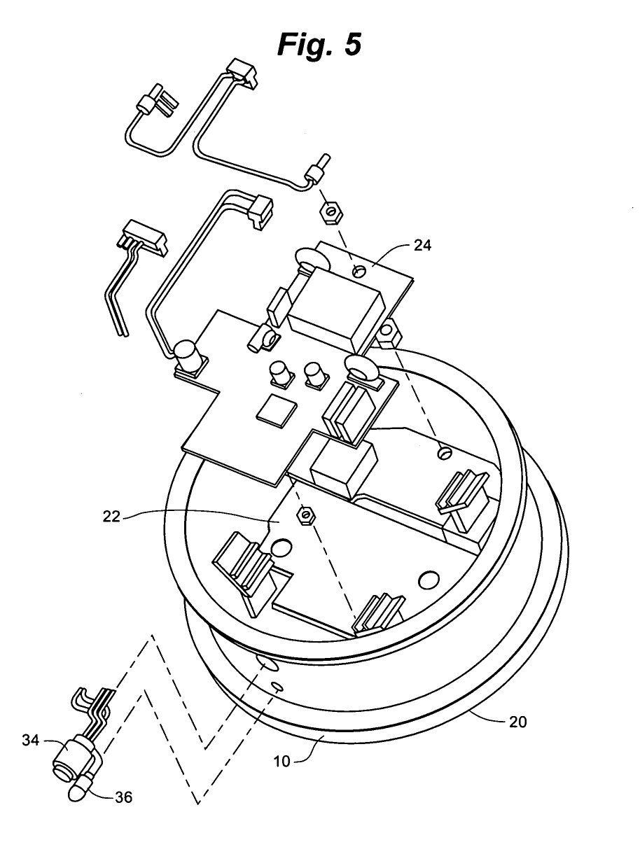

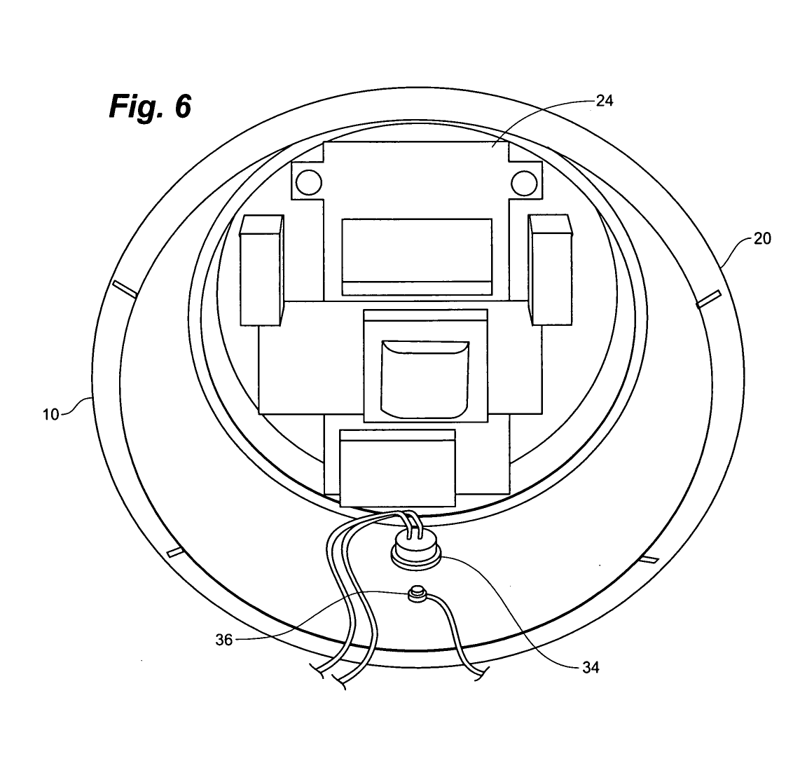

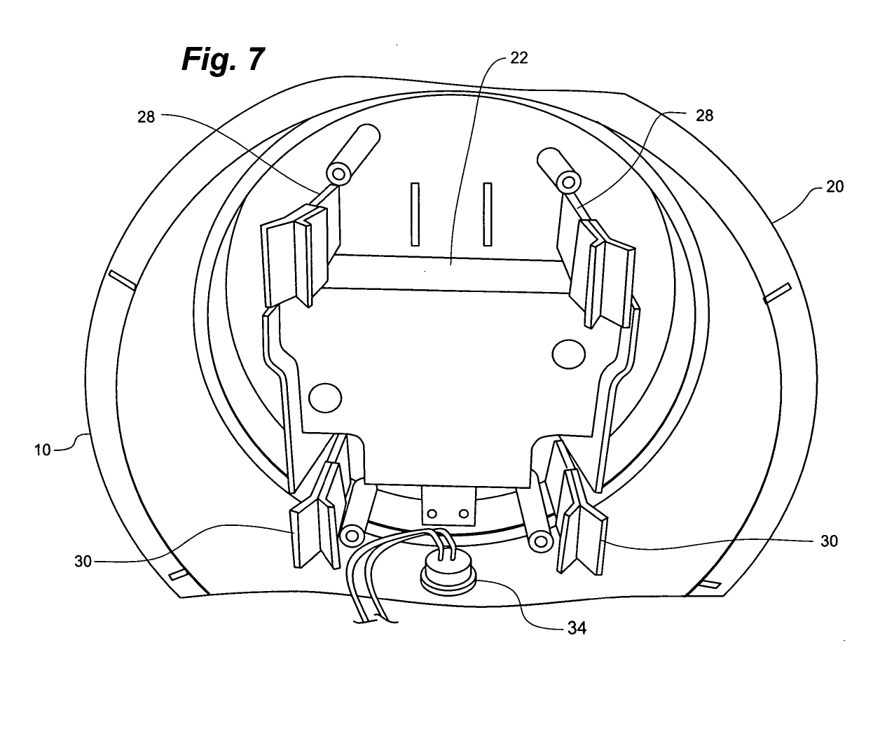

Referring to FIGS. 5-7, disconnect collar 10 is shown in a partially exploded view. A housing 20 contains a relay 22, a printed circuit board (PCB) 24, a first pair of blades 28 and a second pair of blades 30. Housing 20 further includes a reset button 34 and a status indicator 36, disposed on the exterior of said housing 20. Housing 20 may also include a removable cover for PCB 24. In a preferred embodiment, relay 22 comprises a two hundred ampere (200 A) relay, operating at two hundred forty volts of alternating current, at sixty kilohertz. Housing 20 further includes two pairs of blades 28 and 30, which are operably coupled to printed circuit board 24. Relay 22, reset button 34, and status indicator 36 are all also operably coupled to printed circuit board 24. In a preferred embodiment, status indicator 36 comprises some form of indicator observable external to the device, such as a light-emitting diode that is adapted to display different colors or flash a pattern to correspond with an operating condition.

First pair of blades 28 are adapted for transmitting electricity from meter socket 14 to meter 12. Second pair of blades 30 are adapted for transmitting metered power from meter 12 into a home or other location using metered electricity. Each blade consists of a male end and a female end. The male ends of blade pairs 28 and 30 in collar 10 are operably coupled to meter socket 14, and the female ends of blade pairs 28 and 30 in collar 10 are adapted to receive the male ends of identical blades from meter 12. Each blade is constructed from conductive material, and can transmit electricity and data. Blade pairs 28 and 30, therefore, mechanically and electrically couple collar 10, meter 12 and meter socket 14 in a selectively disconnectable manner. Because blade pairs 28 and 30 transmit electricity and data between collar 10 and meter 12, no additional wiring or connections are needed. Collar 10 is therefore quickly and easily removable from between meter 12 and meter socket 14.

Blade pairs 28 and 30 contain identical individual blades, but are differentiated herein as pairs to illustrate electricity and data flow. Each blade in blade pairs 28 and 30 is a standard type blade, which will be appreciated by one skilled in the art. The blades in collar 10 are identical to the blades in meter 12, and collar 10 is therefore selectively disconnectable to meter socket 14 exactly as meter 12 would be selectively disconnectable to meter socket 14. The male ends of the blades in collar 10 engage the sockets in meter socket 14. Similarly, the female ends of the blades in collar 10 accept the male ends of the blades in meter 12, therefore meter 12 is selectively disconnectable to collar 10 just as meter 12 would be selectively disconnectable to meter socket 14. The connections between meter 12, collar 10, and meter socket 14 are not limited to the use of blades. Other connections that create a friction fit between components are also suitable. Further, the use of a cam-lock or similar mechanical engagement arrangement is contemplated. Any connection that effectively engages the components and is also conductive to electricity that would be apparent to one skilled in the art should be considered within the spirit and scope of the invention.

Blade pair 30 is operably coupled to relay 22, such that when relay 22 is switched off, metered electricity is no longer transmitted through blades 30 into a home or other location. Electricity is, however, still available to power meter 12, including the transceiver and circuitry for enabling PLC communications with CCU 90 as will be described.

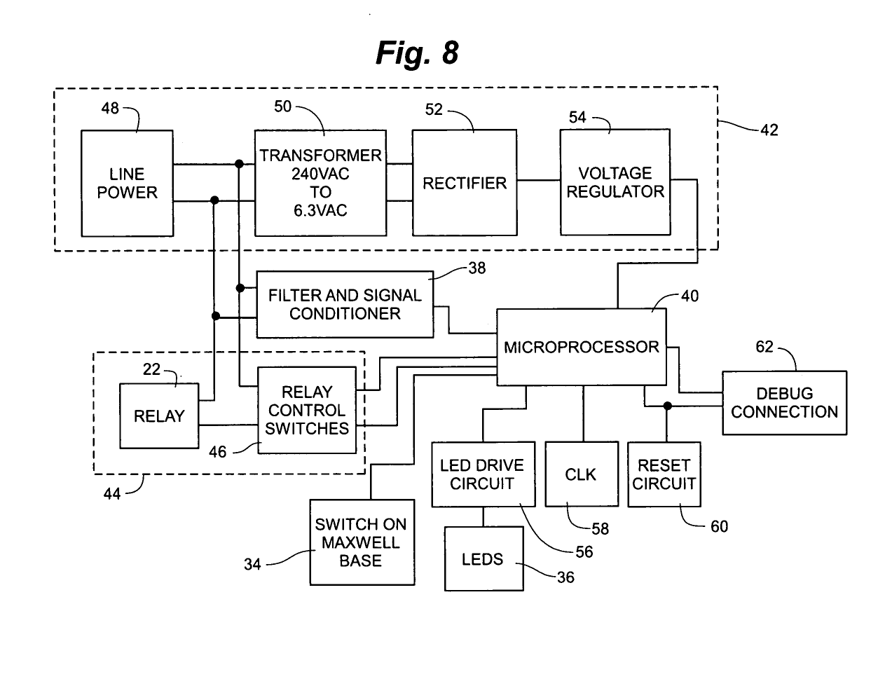

Referring to FIGS. 8-11, a preferred embodiment of a printed circuit board (PCB) 24 in accordance with the present invention includes a signal receiver circuit 38, a microprocessor 40, a power and voltage regulation circuit 42, a relay control circuit 44, and other components. Microprocessor 40 is operably coupled to all components on PCB 24. A block diagram showing the major components of PCB 24 is depicted in FIG. 8. Also coupled to microprocessor 40 are reset button 34, status indicator 36, an LED drive circuit 56, a clock 58, a reset circuit 60, and a debug connection 62.

Although the preferred embodiment is described as being implemented using a microprocessor, it will be understood that alternate embodiments may be implemented in other circuitry configurations, including microcontrollers, FPGAs, ASICs, discrete circuit components or any combination thereof.

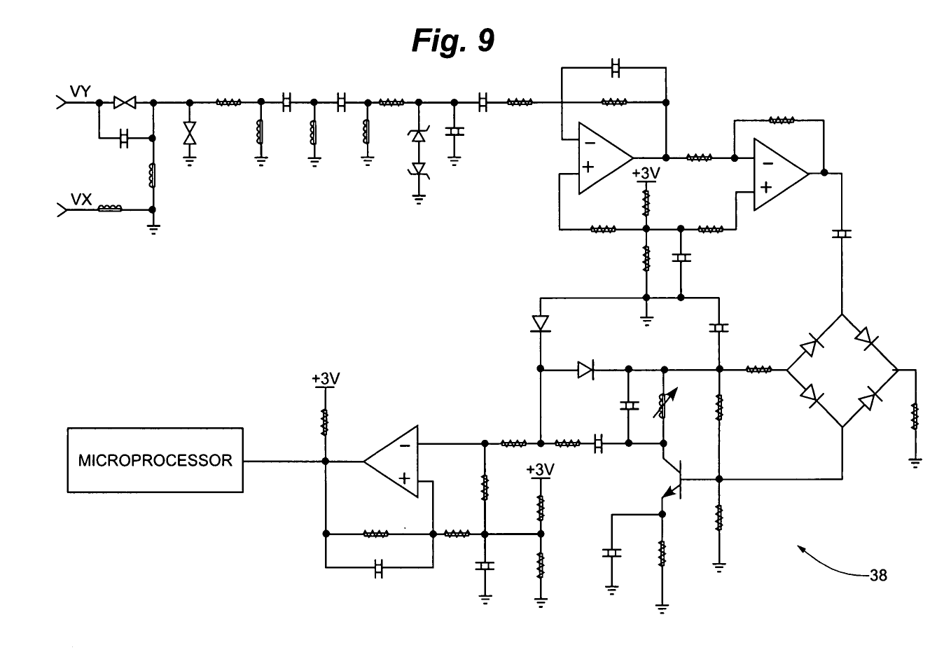

A preferred signal receiver circuit 38 is depicted in FIG. 9. Signal receiver circuit 38 includes filters and signal conditioning to receive data from meter 12 through blade pair 30, and transmit the data to microprocessor 40.

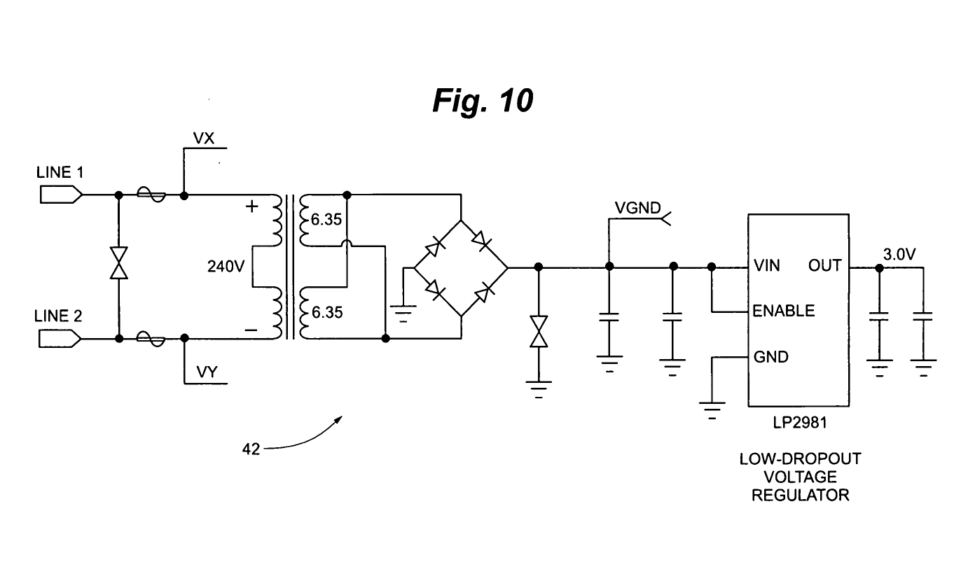

In FIG. 10, a preferred power and voltage regulation circuit 42 is depicted. Power and voltage regulation circuit 42 includes line power 48, a transformer 50, a rectifier 50, and a voltage regulator 54.

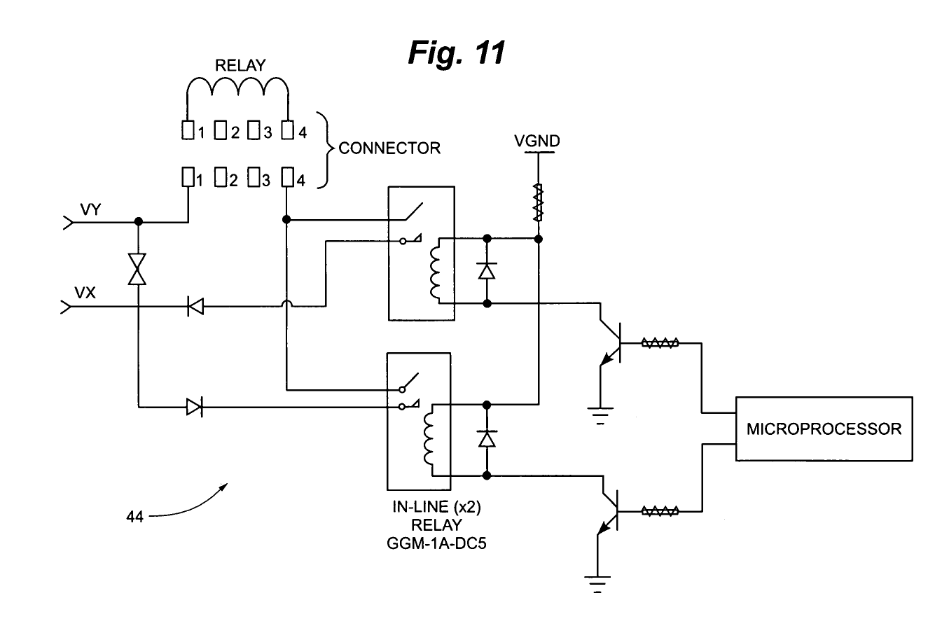

FIG. 11 depicts a preferred relay control circuit 44. Relay control circuit 44 includes relay 22, and relay control switches 46.

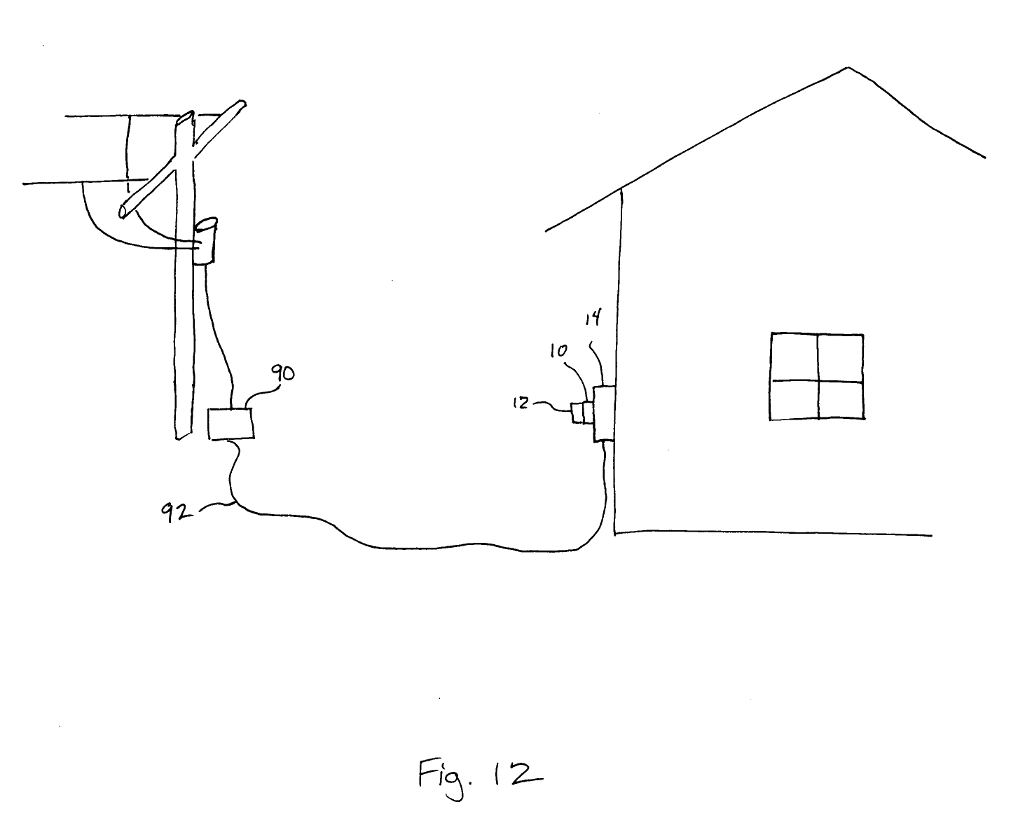

In operation, collar 10 is used to connect or disconnect electricity to a home or other metered electricity location, such as shown in FIG. 12. A central control unit (CCU) 90 is provided as part of a PLC system. CCU 90 acts as a master, and is connected to a plurality of slave devices via power lines 92. Slave devices include collar 10 and meter 12. CCU 90 may control all slave devices on a particular street, or block, or housing development, or neighborhood. CCU 90 is configured to transmit messages or signals over power lines 92. When CCU 90 transmits a message, the message is sent to every device connected to CCU 92. However, each message contains a unique identification number that corresponds to its intended recipient. Each individual device is equipped with a decoder, and each message that a device receives is decoded. If a message is not intended for a device, the device will ignore it.

To disconnect electricity at a particular meter 12, CCU 90 transmits a message onto power lines 92. The message includes a unique identification number corresponding to meter 12. The message passes through meter socket 14 into blade pair 28 of collar 10, and into meter 12. The transceiver 86 (not shown) receives the disconnect message, and transceiver 86 then transmits the disconnect message to collar 10. In this way, meter 12 is a slave to CCU 90, but a master to collar 10. The disconnect message is transmitted to all devices connected to power lines 92, but the message contains a unique identifier to be used only by collar 10. Receiver 38 of collar 10 receives the disconnect message, decodes and processes the message in microprocessor 40, and then activates relay 22 to turn off the electricity supplied from meter socket 14.

Subsequent to a disconnect operation, it may be desired to verify if the disconnect was successful. To do so, CCU 90 may transmit a message to meter 12 over power lines 92 to request usage readings. The message is received by transceiver 86 of meter 12, and a reply message is sent from transceiver 86 to CCU 90. If meter 12 reports any energy usage subsequent to a disconnect operation, the disconnect operation is then known to be unsuccessful.

A PLC system for use with the present invention supports automatic meter reading (AMR). CCU 90 may transmit a message over power lines 92 to a particular meter. The message from CCU 90 may be a request for usage readings from the particular meter. A transceiver in the meter receives the message, and a reply message containing the requested information is sent from the transceiver to CCU 90.

The operating frequency of the PLC system is preferably 9.6 kHz or 12.5 kHz, and the PLC operates in accordance with the protocol communication standards such as described in the PLC standards IEEE 643-2004 “Guide for Power-Line Carrier Applications,” which are incorporated herein by reference. It should be noted that there is a potential for interference between a first message sent to a meter from CCU 90, and a second message sent from a meter to an attached collar. The potential for interference arises because the first and second message are both sent on the same frequency, and each message is transmitted to all devices in the PLC system. However, the second message, sent from the meter to the collar, is a stronger signal due to the close proximity of the meter and the collar. Therefore, in the event that any interference arises between a message sent from the CCU to a meter, and a message sent from a meter to a collar, the message from the meter to the collar should be the dominant signal.

The present invention also supports a load-limiting (or usage restriction) arrangement. In such an arrangement, a predetermined limit is set on how much energy can be used by a particular location. In the event that the limit is exceeded for a predetermined length of time, the electricity supply can be temporarily disconnected. After a predetermined length of time, the electricity is then reconnected. For example, as an alternative to disconnecting power to a location that is not paying for the electricity it uses, a utility company may instead institute a load-limiting arrangement at that location. When that location exceeds a predetermined usage limit for more than the predetermined allowable time, the electricity is disconnected. Meter 12 is configured to have a usage limit, and compare actual electricity usage to the limit. If actual usage exceeds the limit for longer than a predetermined period of time (for example five minutes), then meter 12 transmits a disconnect message to collar 10. The message is sent from transceiver 86 in meter 12 to receiver 38 in collar 10 via second blade pair 30. Collar 10 then energizes relay 22 and disconnects electricity to the location. After a predetermined amount of time (for example five minutes), meter 12 transmits a connect message to collar 10 in the same manner as a disconnect message is transmitted, and relay 22 reconnects electricity service. Collar 10 may be configured such that reset button 34 must be physically pushed after relay 22 connects electricity before service is restored.

Disconnect collar 10 is easily installed at, or removed from an existing location. To install a collar 10, power must be shut off at the location. Meter 12 is then removed from meter socket 14. Collar 10 is installed into meter socket 14 such that the male ends of blade pairs 28 and 30 engage with the receiving sockets in meter socket 14. Meter 12 is then installed into collar 10 such that the male ends of the blades in meter 12 engage with the female ends of blade pairs 28 and 30 in collar 10. Collar 10 is then physically installed. To activate collar 10, CCU 90 transmits an initialization message that is received by meter 12. The message alerts meter 12 that it is now operably coupled to a disconnect collar 10, and meter 12 and collar are thereinafter operational.

To remove a collar 10 from a location, power is first disconnected by sending a message from CCU 90 to meter 12, meter 12 transmits a disconnect message to collar 10, collar 10 activates relay 22, and power is disconnected. Then meter 12 is physically removed from collar 10, and collar 10 is physically removed from meter socket 14. Meter 12 is then installed directly to meter socket 14. Power must be reconnected in person, and once power has been restored, CCU 90 transmits a message to meter 12 alerting meter 12 that collar 10 is no longer attached. Thus, collar 10 is quickly and easily installed or removed.

Details of the present invention may be modified in numerous ways without departing from the spirit or scope of the present invention. Various components of the present invention may be altered in shape or size without affecting the functionality of the device.

Although the present invention has been described with reference to particular embodiments, one skilled in the art will recognize that changes may be made in form and detail without departing from the spirit and scope of the invention. Therefore, the illustrated embodiments should be considered in all respects as illustrative and not restrictive.

1. (canceled)

2. (canceled)

3. A remote-activated collar for use in a power line communication arrangement, the collar removably engaged between an electric meter and a meter socket associated with a metered location, the collar comprising:
a receiver adapted to receive a message from the electric meter;
a relay adapted to connect or disconnect electrical power to the metered location;
one or more blades having a male end and a female end, the male end adapted to selectively engage the collar with the meter socket, and the female end adapted to selectively engage the electric meter with the collar;
wherein the collar is adapted to connect or disconnect electrical power to the metered location in response to the message.

4. The remote-activated collar of claim 3, further comprising a status indicator observable external to the electric meter and the collar.

5. A remote-activated power line communication system for use with an electrical utility delivering electrical power over power lines, the system comprising:
an electric meter having a transceiver that receives messages and transmits messages, and an electrically conductive engagement means;
a remote disconnect collar having a receiver that receives messages, a relay, and an electrically conductive means;
a meter socket having an electrically conductive means, wherein the remote disconnect collar is electrically and mechanically coupled between the electric meter and the meter socket; and
a central control unit adapted to transmit messages to and receive messages from the electric meter using the power lines, wherein the remote disconnect collar activates the relay in response to the receipt of a message from the central control unit to connect or disconnect electricity at a metered location associated with the meter socket.

6. The power line communication system of claim 5, wherein the central control unit is adapted to communicate with and control disconnect collars and electric meters at multiple metered locations.

7. The power line communication system of claim 6, wherein each message includes a unique identifier, and each disconnect collar and each electric meter includes a decoder that reads the unique identifier, such that a message will only be acted upon by the disconnect collar and the electric meter corresponding to the unique identifier in the message.

8. The power line communication system of claim 5, wherein the electric meter comprises a digital solid-state meter.

9. A method of connecting and disconnecting electrical power to a metered location, the method comprising:
transmitting a message over power lines from a control station to an electric meter;
receiving the message with a transceiver within said electric meter;
transmitting information representative of the message from the electric meter to a collar, the collar being operably and conductively coupled between the electric meter and a meter socket associated with a metered location; and
activating a relay within the collar in response to the information representative of the message received from the electric meter, thereby connecting or disconnecting electrical power to the metered location.

10. The method of claim 9, further comprising verifying the success of an electrical disconnect or connect operation wherein the control station transmits a request for power usage over power lines to the electric meter.

11. The method of claim 10, further comprising:
physically removing the collar from the metered location subsequent to a successful disconnection of electrical power;
installing the collar at a second metered location between a second electric meter and a second meter socket associated with the second metered location;
transmitting a message over power lines from a control station to the second metered location;
receiving the message within the second electric meter;
transmitting information representative of the message from the second electric meter to the collar; and
activating the relay within the collar in response to the information representative of the message, thereby connecting electrical power to the second metered location.

12. The method of claim 11, wherein each message includes a unique identifier, and the disconnect collar and each electric meter includes a decoder that reads the unique identifier, such that a message will only be acted upon by the disconnect collar and the electric meter corresponding to the unique identifier in the message.

13. A method of restricting electrical usage at a metered location, comprising:
providing an electrical meter having a predetermined electrical usage limit;
monitoring the electrical usage at the metered location with the electrical meter;
comparing the electrical usage to the predetermined limit;
temporarily disconnecting electricity at the metered location in response to an electrical usage in excess of the predetermined limit for greater than a predetermined allowable length of time, the disconnecting including:
transmitting a disconnect message from the electrical meter to a collar;
receiving the message by the collar; and
activating a relay by the collar to disconnect electricity; and
restoring electricity after a predetermined length of time, including:
transmitting a connect message from the electrical meter to the collar;
receiving the message by the collar; and
activating a relay by the collar to connect electricity.

14. The method of 13, wherein the step of restoring electricity further comprises providing a manual reset mechanism on the collar that must be physically activated before electricity is restored.
